(19) United States
(12) Patent Application Publication
(10) Pub. No.: US 2011/0080741 A1
(43) Pub. Date: Apr. 7, 2011

(54) LIGHTING FIXTURE

(76) Inventor: Si Chung Noh, Gyeonggi-do (KR)

(21) Appl. No.: 12/888,519

(22) Filed: Sep. 23, 2010

(30) Foreign Application Priority Data
Oct. 6, 2009 (KR) 10-2009-0094426
Jan. 14, 2010 (KR) 10-2010-0003295

(51) Int. Cl. F21V 29/00; F21V 7/00

(52) U.S. Cl. 362/294; 362/296.01

(57) ABSTRACT

Disclosed is a lighting fixture. The lighting fixture includes reflecting part having an opening which penetrates the reflecting part, a light source irradiating light toward the reflecting part, a mounting part which mounts the light source thereon, a circuit part disposed at an opposite side to the opening of the reflecting part and driving the light source, and a power connecting part supplying power from outside to the circuit part. With this lighting fixture, since light irradiated from the light source is reflected by the reflecting part before exiting the lighting fixture, the light is not directly emitted towards a user, thereby reducing glare. Further, the reflecting part, the light source, the circuit part and the power connecting part are combined into an integrated module, thereby permitting easy installation while providing a compact outer appearance.

### BACKGROUND OF THE INVENTION

1. Field of the Invention

The present invention relates to lighting fixtures and, more particularly, to lighting fixtures which irradiate light.

2. Description of the Related Art

Lighting fixtures are used for interior decoration or to create a cozy atmosphere as well as for simple illumination. Such lighting fixtures generally include an incandescent lamp or a fluorescent lamp.

Since the incandescent lamp employs simple accessories for lighting and is readily combined with other lighting devices, the incandescent lamp still occupies a significant market share despite advances in fluorescent lighting. The fluorescent lamp has merits such as higher efficiency and longer lifespan than the incandescent lamp which employs a filament, and thus, like the incandescent lamp, holds a large market share.

In recent years, iodine lamps using a halogen cycle, high-efficiency halide lamps, solar-powered lamps, etc. have been developed and put to practical use. Further, an electroluminescent (EL) lamp, which includes a crystalline luminous body and is used as a surface light source, has attracted attention as a next generation light source.

A light emitting diode (LED), that is, a photoelectronic device, is also used as a light source for lighting fixtures. Specifically, the LED is used in a broad range of applications including large exterior electronic display boards, traffic lights, vehicle instrument boards, medical instruments, warning lights, etc., and is attracting attention as a light source due to merits, such as low power consumption compared with incandescent or fluorescent lamps, semi-permanent lifespan, environmentally friendliness, and the like.

In such a lighting fixture, a user passing by the lighting fixture is not only directly irradiated with light from a light source, causing glare, but the light source, a mirror and a circuit unit are also separately provided to the lighting fixture, complicating installation and resulting in a non-compact appearance. Therefore, there is a need to provide an improved lighting fixture.

Here, it should be noted that the above description is provided for understanding of the background of the invention and is not a description of a well-known technique in the art to which the invention pertains.

### SUMMARY OF THE INVENTION

The present invention is directed to solving the problems of the related art as described above, and an aspect of the present invention is to provide a lighting fixture that is configured not only to reduce glare and permit easy installation, but also to have a compact outer appearance.

In accordance with one aspect, the present invention provides a lighting fixture including: a reflecting part having an opening which penetrates the reflecting part; a light source irradiating light toward the reflecting part; a mounting part which mounts the light source thereon; a circuit part disposed at an opposite side to the opening of the reflecting part and driving the light source; and a power connecting part which supplies power from an exterior to the circuit part.

The mounting part may be disposed at a side of the opening of the reflecting part.

The mounting part may extend toward a side of the opening and the light source may be disposed at a side of the reflecting part.

The mounting part may extend outside the opening and the light source may be disposed to irradiate light toward an outer side of the reflecting part.

The mounting part may be detachably mounted to the reflecting part.

The light source may be inserted into a mounting groove formed in the mounting part.

The reflecting part may further include a heat dissipating section for dissipating heat generated from the light source.

The lighting fixture may further include a diffusing part disposed at the opening.

The mounting part may be mounted to allow distance adjustment from the reflecting part.

The reflecting part may be mounted to allow distance adjustment from the circuit part.

The lighting fixture may further include a housing outside the reflecting part.

The housing may be mounted to be liftable.

The mounting part may extend lengthwise in one direction, and the light source may be provided in plural numbers in a longitudinal direction of the mounting part.

The lighting fixture may further include a distance adjusting part which adjusts a distance between the power connecting part and the reflecting part.

### BRIEF DESCRIPTION OF THE DRAWINGS

The above and other features and advantages of the invention will become apparent from the following description of embodiments given in conjunction with the accompanying drawings, in which:

FIG. 1 is a perspective view of a lighting fixture according to a first embodiment of the present invention;

FIG. 2 is a sectional view of the lighting fixture of FIG. 1;

FIGS. 3 to 6 are sectional views of a lighting fixture according to a second embodiment of the present invention;

FIG. 7 is a perspective view of a lighting fixture according to a third embodiment of the present invention;

FIG. 8 is a sectional view of the lighting fixture of FIG. 7;

FIG. 9 is a sectional view of a lighting fixture according to a fourth embodiment of the present invention;

FIG. 10 is a perspective view of a lighting fixture according to a fifth embodiment of the present invention;

FIGS. 11 and 12 are perspective views showing a lighting fixture according to a sixth embodiment of the present invention;

FIG. 13 is a sectional view of a lighting fixture according to a seventh embodiment of the present invention;

FIG. 14 illustrates operation of the lighting fixture of FIG. 13;

FIG. 15 is a perspective view of a lighting fixture according to an eighth embodiment of the present invention;

FIG. 16 is a sectional view of the lighting fixture of FIG. 15;

FIG. 17 is a sectional view of a lighting fixture according to a ninth embodiment of the present invention;

FIG. 18 illustrates operation of the lighting fixture of FIG. 17;

FIG. 19 is a perspective view of a lighting fixture according to a tenth embodiment of the present invention; and

FIG. 20 is a perspective view of a lighting fixture according to an eleventh embodiment of the present invention.

### DETAILED DESCRIPTION OF EMBODIMENTS

Embodiments of a lighting fixture according to the invention will be described with reference to the accompanying drawings, in which like elements will be denoted by like reference numerals. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosure set forth herein.

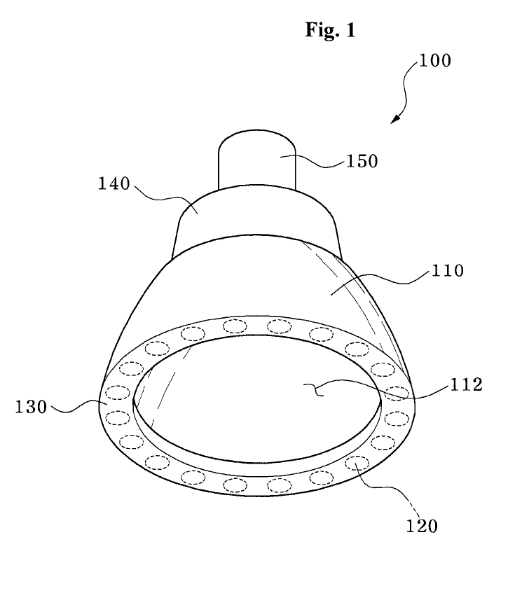

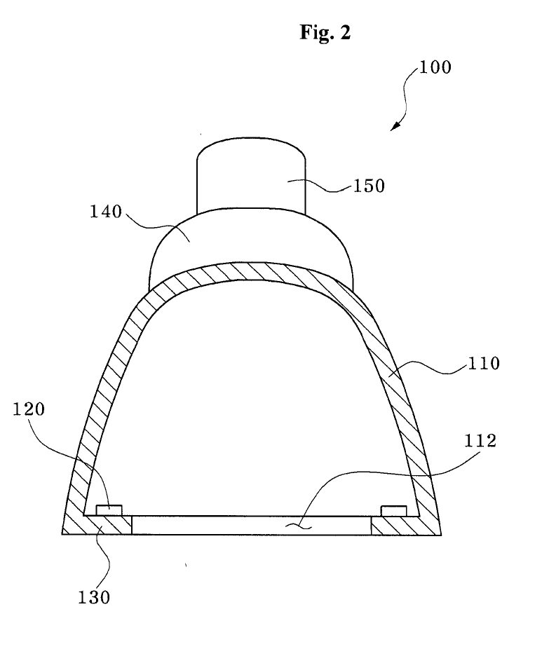

FIG. 1 is a perspective view of a lighting fixture according to a first embodiment and FIG. 2 is a sectional view of the lighting fixture of FIG. 1

Referring to FIGS. 1 and 2, the lighting fixture 100 according to the first embodiment includes a reflecting part 110, a light source 120, a mounting part 130, a circuit part 140 and a power connecting part 150.

The reflecting part 110 reflects light irradiated from the light source 120 described below. In this embodiment, the reflecting part 110 is shaped like a bell, an upper diameter of which is smaller than a lower diameter. The reflecting part 110 includes an opening 112. The opening 112 is formed to penetrate a lower side of the reflecting part 110. The reflecting part 110 may include interior reflecting plates for reflecting light or may be coated with a fluorescent material. It should be understood that the reflecting part 110 may be modified in a variety of ways.

The reflecting part 110 is made of a material capable of reflecting light irradiated from the light source 120. Advantageously, the reflecting part 110 may be made of a material that can dissipate heat generated from the light source 120 while reflecting light irradiated from the light source 120. For example, the reflecting part 110 may be made of metal, such as copper, aluminum, etc.

The light source 120 irradiates light toward the reflecting part 110. For example, the light source 120 may have any structure which includes at least one of a light emitting diode (LED) module and an organic light emitting diode (OLED) module. In one embodiment, a blue LED module may be employed as the light source 120. The light source 120 may be provided to emit a single color or a combination of different colors.

The light source 120 is provided to the mounting part 130. In this embodiment, the mounting part 130 is disposed at a side of the opening 112 of the reflecting part 110. The mounting part 130 extends from a lower end of the reflecting part 110 toward the opening 112.

Alternatively, the mounting part 130 may be disposed at an upper portion of the opening 112, i.e., on an inner wall of the reflecting part 110, and extend from the inner wall of the reflecting part 110.

The mounting part 130 may be integrally formed with the reflecting part 110. In this embodiment, the mounting part 130 is formed by bending the reflecting part 110. In this manner, the mounting part 130 is integrally formed with the reflecting part 110, so that the reflecting part 110 and the light source 120 can be configured as an integrated module.

Further, the light source 120 is mounted on the mounting part 130 inside the reflecting part 110. Accordingly, the light source 120 irradiates light toward an inner surface of the reflecting part 110, and the light is reflected from the inner surface of the reflecting part 110 to the outside.

The circuit part 140 is disposed at an opposite side to the opening 112 of the reflecting part 110 to drive the light source 120. In this embodiment, the circuit part 140 converts input power, which is supplied from the power connecting part 150 described below, into direct current (DC) power, and then supplies the converted DC power to the light source 120, thereby supplying power for lighting the light source 120. Further, the circuit part 140 may adjust lighting, intensity of illumination, and color temperature of the light source 120 through dimming control, thereby enabling the light source 120 to emit various intensities and color temperatures of light.

The circuit part 140 is disposed on an upper portion of the reflecting part 110 and may be integrally formed with the reflecting part 110. In this embodiment, the reflecting part 110 is integrally formed with the circuit part 140, so that the reflecting part 110, the light source 120 and the circuit part 140 are combined into an integrated module, thereby providing a compact outer appearance.

The power connecting part 150 supplies power from the exterior to the circuit part 140. In this embodiment, the power connecting part 150 receives alternating current (AC) power from the exterior and supplies the AC power to the circuit part 140. The power connecting part 150 may be made of a conductive material to receive the AC power from the exterior.

According to the embodiment, the lighting fixture 100 allows light irradiated from the light source 120 to exit the lighting fixture after being reflected by the reflecting part 110, so that the light is indirectly emitted towards a user, thereby reducing glare.

Further, since the reflecting part 110, the light source 120, the circuit part 140 and the power connecting part 150 are combined into an integrated module, the lighting fixture 100 of this embodiment is not only easy to install, but also has a compact outer appearance.

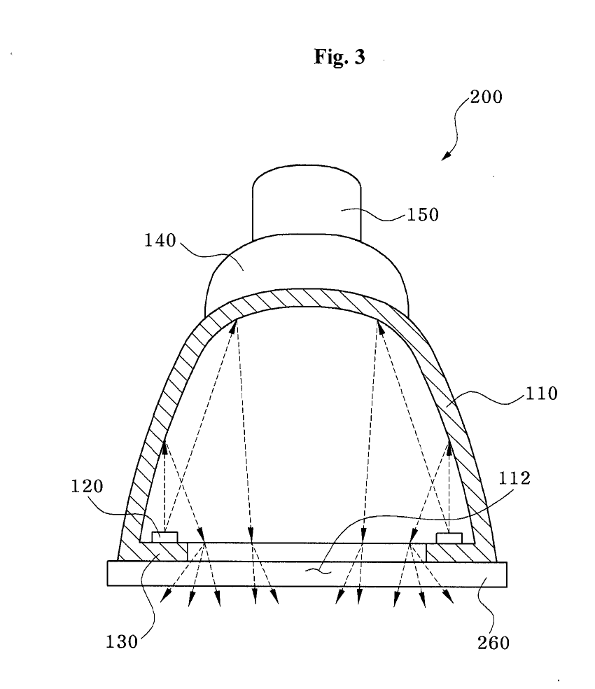

FIGS. 3 through 6 are sectional views of a lighting fixture according to a second embodiment of the present invention.

Referring to FIG. 3, the lighting fixture 200 according to the second embodiment includes a diffusing part 260 disposed at an opening 112. The diffusing part 260 is disposed on a lower side of a reflecting part 110 and closes the opening 112, thereby diffusing light reflected in the reflecting part 110 as the light exits the lighting fixture. In this embodiment, the diffusing part 260 may be made of a transparent or translucent material.

The diffusing part 260 may have various colors. As the diffusing part 260 has various colors, the color of the diffusing part 260 is mixed with light irradiated from a light source 120, thereby providing various colored lighting effects. The diffusing part 260 may protrude outside the reflecting part 110 and have a variable length depending upon protruded areas of the reflecting part 110 and the mounting part 130.

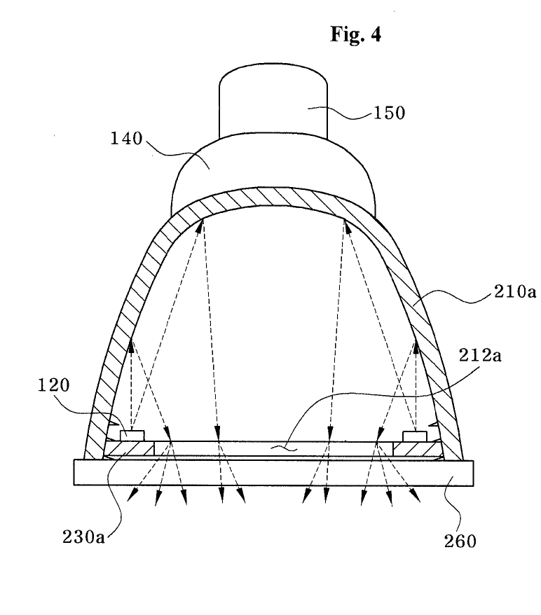

FIG. 4 shows another example of the mounting part.

Referring to FIG. 4, a mounting part 230a extends from a lower end of a reflecting part 210a towards an opening 212a. The mounting part 230a is not formed by bending the reflecting part 210a, but is provided as a separate member and coupled to an inner wall of the reflecting part 210a.

The mounting part 230a may be detachably provided to the reflecting part 210a. The detachable structure of the mounting part 230a may be achieved by screw-coupling the entirety of the mounting part 230a with the light source 120 mounted thereon into a thread formed in the reflecting part 210a, or by screw-coupling the reflecting part 210a to a thread formed in the mounting part 230a. Here, it should be understood that this structure can be modified in various ways.

With this coupling structure between the reflecting part 210a and the mounting part 230a, not only may the mounting part 230a be formed on the reflecting part 210a through simple assembly instead of bending the reflecting part to form the mounting part 230a, thereby simplifying manufacture of the reflecting part 210a, but the mounting part 230a may also be detached or attached as needed, thereby facilitating maintenance and repair of components, for example, replacement of the light source.

The reflecting parts 110 and 210a as shown in FIGS. 1 to 4 may have various shapes, such as a Ω-shape, a T-shape, etc., as well as the bell shape.

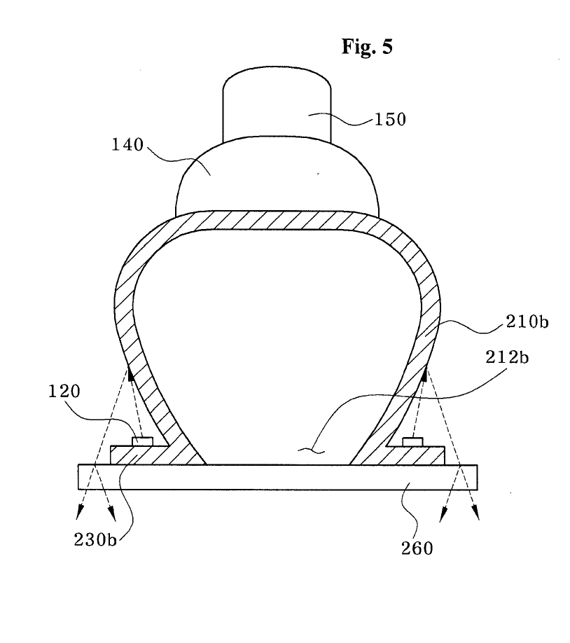

For example, referring to FIG. 5, a reflecting part 210b has a Ω-shape. Here, the term “Ω-shape” means a shape in which a middle portion bulges and a lower end extends outside an opening 212b. Here, it should be understood that the reflecting part 210b may be modified in a variety of ways. For example, the portion extending outside the opening 212b may extend horizontally and have a distal end further extending upward or downward.

A mounting part 230b disposed at a side of the opening 212b of the reflecting part 210b extends outside the opening 212b. The light source 120 mounted on the mounting part 230b as described above is disposed outside the reflecting part 210b and irradiates light towards an outer side of the reflecting part 210b. Then, the light is reflected by the outer side of the reflecting part 210b toward a diffusing part 260, and exits the lighting fixture while being diffused through the diffusing part 260.

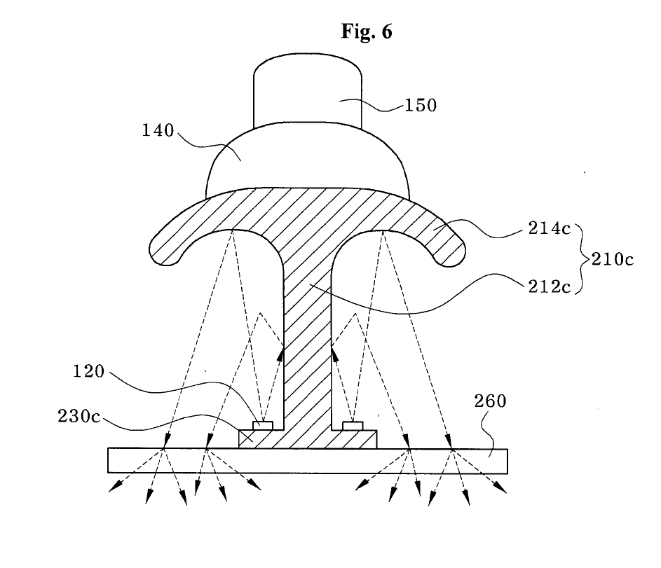

Alternatively, referring to FIG. 6, a reflecting part 210c has a T-shape. Here, the term “T-shape” means a shape in which a cover 214c is horizontally located on an upper end of a column 212c disposed in a vertical direction. At least one of the column 212c and the cover 214c may be inclined or curved.

A mounting part 230c disposed at a lower side of the reflecting part 210c extends outward from the lower side of the reflecting part 210c. The light source 120 mounted on the mounting part 230c as described above irradiates light towards a lower side of the cover 214c. Then, the light is reflected by the lower side of the cover 214c toward the diffusing part 260 and exits the lighting fixture while being diffused through the diffusing part 260.

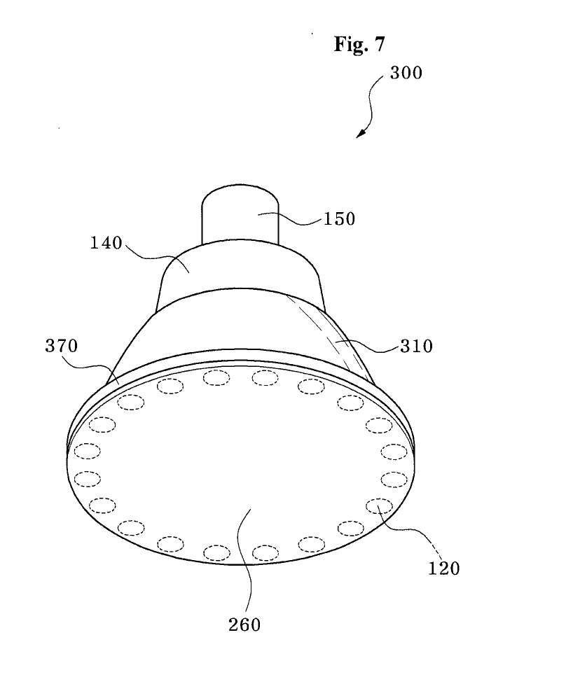

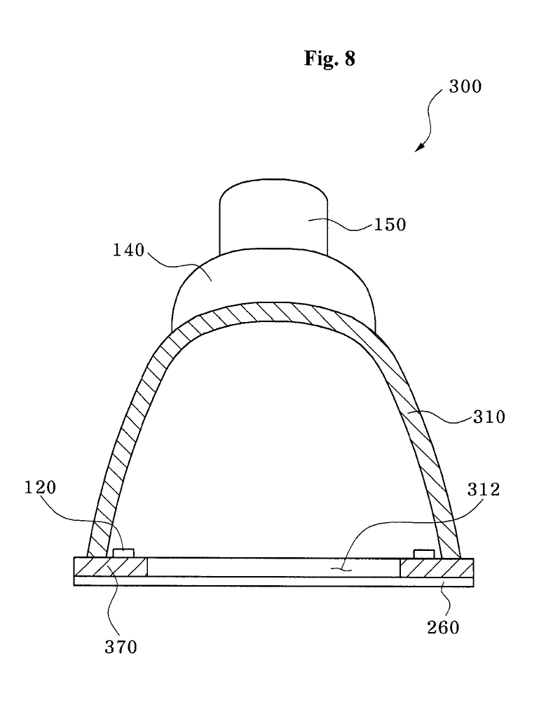

FIG. 7 is a perspective view of a lighting fixture according to a third embodiment, and FIG. 8 is a sectional view of the lighting fixture of FIG. 7.

Referring to FIGS. 7 and 8, the lighting fixture 300 according to the third embodiment includes a frame unit 370. The frame unit 370 is provided to an opening 312 of a reflecting part 310 to be disposed between the reflecting part 310 and a diffusing part 260. The frame unit 270 has a ring shape corresponding to a lower side of the reflecting part 310, and partially closes the lower side of the reflecting part 310. That is, the lower side of the reflecting part 310 is closed around a lateral wall thereof by the frame unit 370, and a central portion of the lower side of the reflecting part 310 is opened.

According to this embodiment, the light source 120 is disposed on the frame unit 370 inside the reflecting part 310. Thus, the light source 120 irradiates light toward an inner surface of the reflecting part 310 and the light is reflected by the inner surface of the reflecting part 310 and then exits the lighting fixture while being diffused through the diffusing part 260 via the central portion of the frame unit 370.

According to this embodiment, the light source 120 may be mounted on the reflecting part 310 through simple assembly, thereby enabling easy manufacture of the lighting fixture, and the detachable structure of the frame unit 370 facilitates maintenance and repair of components of the lighting fixture, for example replacement of the light source 120 and the like.

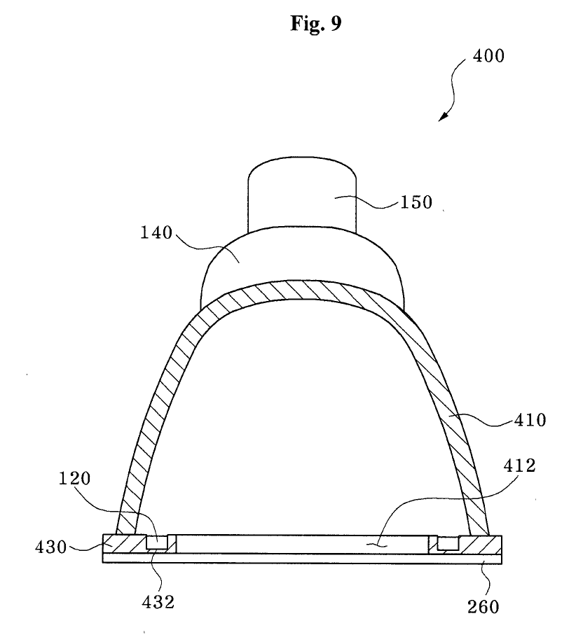

FIG. 9 is a sectional view of a lighting fixture according to a fourth embodiment.

Referring to FIG. 9, the lighting fixture 400 according to the fourth embodiment includes a mounting part 430. The mounting part 430 is disposed at a side of opening 412 of a reflecting part 410 and extends from a lower end of the reflecting part 410 toward the opening 412. The mounting part 430 has a mounting groove 432, which is concavely formed thereon and opened toward an inside of the reflecting part 410.

In this embodiment, the light source 120 is mounted on the mounting part 430. Specifically, the light source 120 is inserted into the mounting groove 432. Then, the light source 120 has no outward projection, thereby preventing fracture due to external force.

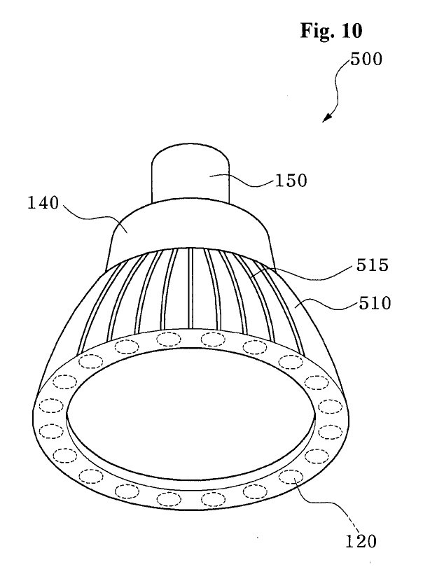

FIG. 10 is a perspective view of a lighting fixture according to a fifth embodiment.

Referring to FIG. 10, the lighting fixture 500 according to the fifth embodiment includes a reflecting part 510 having a heat dissipating section 515. The heat dissipating section 515 is disposed on an outer side of the reflecting part 510 and dissipates heat generated by the light source 120. In this embodiment, the heat dissipating section 515 includes a plurality of protrusions formed on the outer side of the reflecting part 510.

When the light source 120 is turned on to irradiate light, the reflecting part 510 receives heat generated by the light source 120 as a by-product of light generation. As such, the heat transferred to the reflecting part 510 is dissipated through the reflecting part 510, in which the heat dissipating section 515 serves to enhance heat dissipation effects of the reflecting part 510 by increasing a surface area of the outer side of the reflecting part 510 in contact with air. The lighting fixture 500 having improved heat dissipation effects of the reflecting part 510 prevents the light source 120 from being deteriorated due to overheating, thereby enhancing mechanical reliability.

In this embodiment, the heat dissipating section 515 is formed on the outer side of the reflecting part 510, but is not limited thereto. Alternatively, the heat dissipating section 515 may be formed on an inner surface of the reflecting part 510. Alternatively, the heat dissipating section may have a concave shape, for example grooves, rather than the protrusions, or may be formed as through-holes in the reflecting part 510. As such, the heat dissipating section can be modified in a variety of ways.

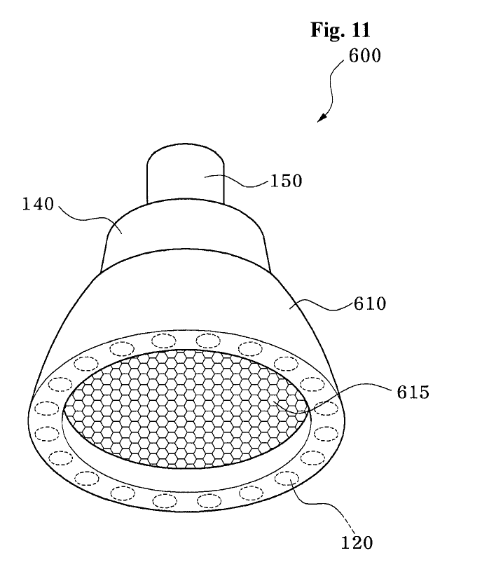

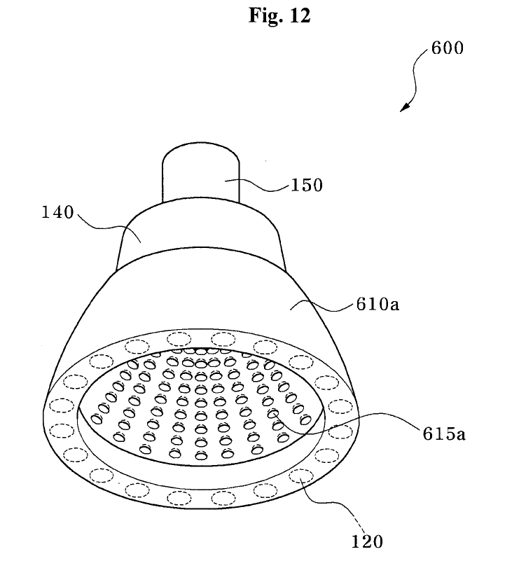

FIGS. 11 and 12 are perspective views of a lighting fixture according to a sixth embodiment.

Referring to FIG. 11, the lighting fixture 600 according to the sixth embodiment includes a reflecting part 610 having a honeycomb member 615. The honeycomb member 615 has a honeycomb shape and is formed on an inner surface of the reflecting part 610 to make diffuse reflection of light irradiated from the light source 120. Here, the honeycomb shape is well known in the art, and a detailed description thereof will be omitted herein.

According to this embodiment, not only does the lighting fixture 600 having the honeycomb member 615 improve reflectivity by diffuse-reflecting the light irradiated from the light source 120, but also enhances heat dissipation effects through an increased surface area of the reflecting part 610.

In this embodiment, the honeycomb member 615 has a honeycomb shape but the invention is not limited thereto. Alternatively, various modifications are possible so long as they can cause diffuse reflection.

FIG. 12 shows another example of the reflecting part.

Referring to FIG. 12, a reflecting part 610a includes a plurality of retro-reflecting portions 615a. In this embodiment, the plurality of retro-reflecting portions 615a are adjacent to or spaced apart from one another, and each retro-reflecting portion 615a is recessed in the form of a hemisphere on an inner surface of the reflecting part 610a. Here, the retro-reflecting portion 615a is obvious to those skilled in the art and a detailed description thereof will be omitted. The retro-reflecting portion 615a causes diffuse reflection of light irradiated from the light source 120 to thereby improve reflectivity, and increases the surface area of the reflecting part 610a to thereby enhance heat dissipation effects of the reflecting part 610a.

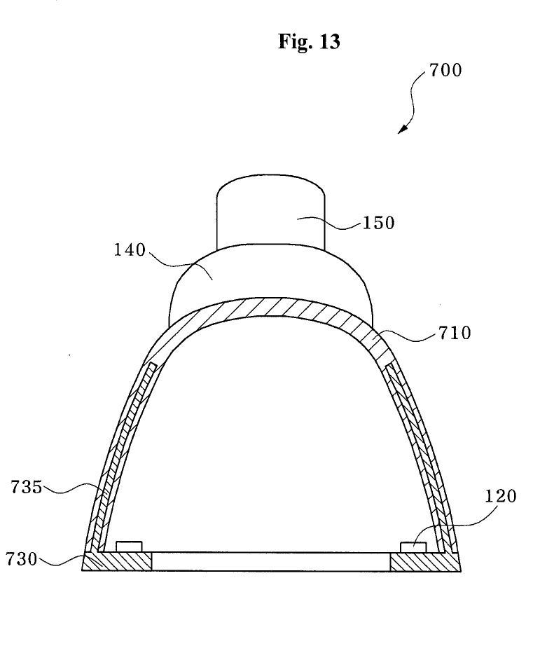

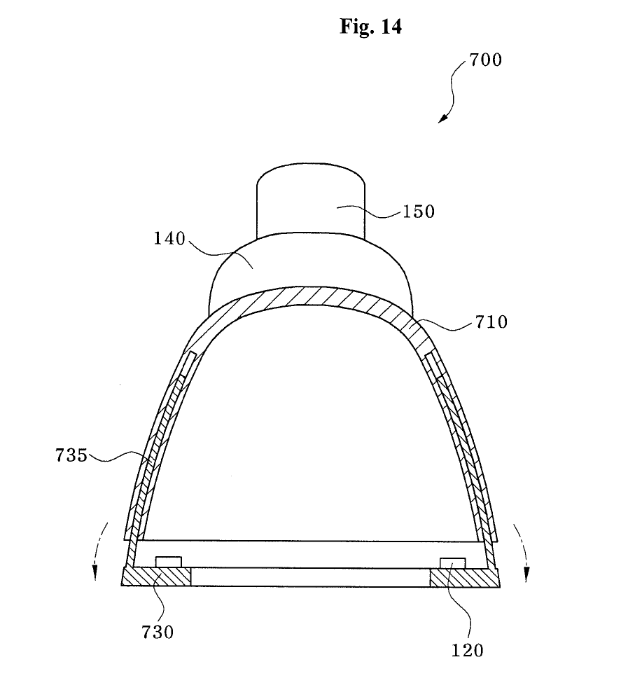

FIG. 13 is a sectional view of a lighting fixture according to a seventh embodiment, and FIG. 14 illustrates operation of the lighting fixture of FIG. 13.

Referring to FIGS. 13 and 14, the lighting fixture 700 according to the seventh embodiment includes a mounting part 730 disposed to permit adjustment of the distance from a reflecting part 710. In this embodiment, the mounting part 730 includes a sliding member 735 slidably inserted into an insertion groove (reference numeral omitted) formed on an inner wall of the reflecting part 710. The sliding member 735 may be made of a flexible material to be curved corresponding to the shape of the insertion groove. The sliding member 735 may be provided therein with an auxiliary reflecting section (not shown) for reflecting light.

In this embodiment, lighting position, intensity of illumination, etc. of the lighting fixture 700 including the mounting part 730 are varied as needed by adjusting the distance between the mounting part 730 and the reflecting part 710, i.e., between the light source 120 and the reflecting part 710, thereby achieving various lighting effects.

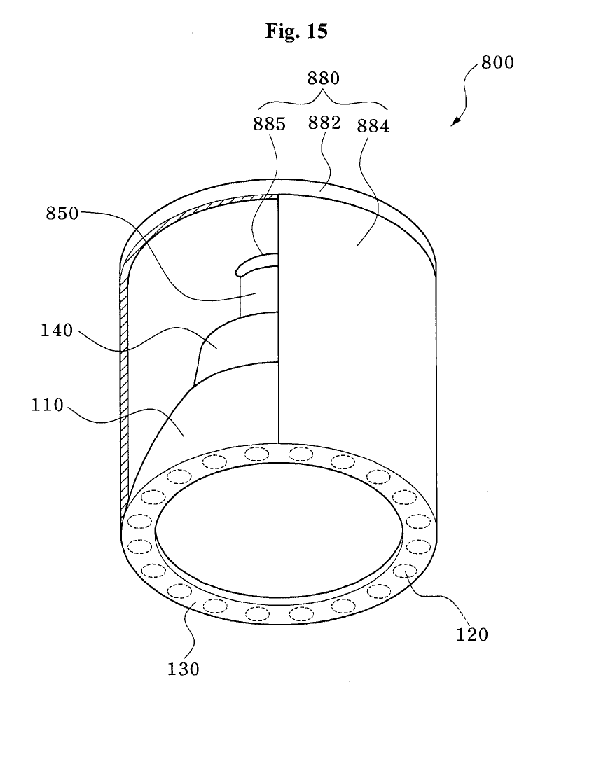

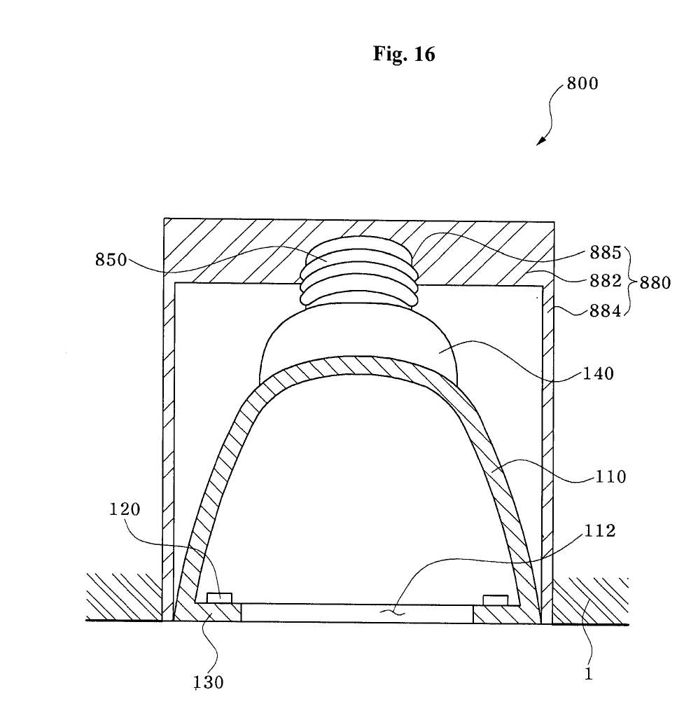

FIG. 15 is a perspective view of a lighting fixture according to an eighth embodiment, and FIG. 16 is a sectional view of the lighting fixture of FIG. 15.

Referring to FIGS. 15 and 16, the lighting fixture 800 according to the eighth embodiment includes a housing 880 outside a reflecting part 110. The housing 880 is embedded in a ceiling or the like, and includes a body 882 coupled to a power connecting part 850 and an extension section 884 extending along an edge of the body 882 to define a space inside the housing 880.

In this embodiment, the body 882 of the housing 880 is formed with a coupling groove 885, and the power connecting part 850 is inserted into the coupling groove 885 and detachably coupled to the body 882. Namely, the integrated module, which is integrally composed of the reflecting part 110, the light source 120, the circuit part 140 and the power connecting part 850, may be detachably coupled to the housing 880 through detachable coupling between the power connecting part 850 and the body 882.

For example, the power connecting part 850 is formed with threads on an outer side thereof and is screw-coupled to the coupling groove 885, so that the power connecting part 850 may be detachably coupled to the body 882. Thus, the power connecting part 850 detachably coupled to the housing 880 through the screw coupling has enhanced coupling force with the housing 880 and allows the height of the integrated module, which is integrally composed of the reflecting part 110, the light source 120, the circuit part 140 and the power connecting part 850, to be varied depending on the degree of rotating the power connecting part 850 when coupling the power connecting part 850 to the housing 880.

In the lighting fixture 800 of this embodiment, the housing 880 encloses and protects the module, which is integrally composed of the reflecting part 110, the light source 120, the circuit part 140 and the power connecting part 850, thereby enhancing mechanical reliability.

In this embodiment, the housing 880 and the lighting fixture 800 having the same are embedded in a ceiling but the present invention is not limited thereto. Alternatively, the housing 880 and the lighting fixture 800 may be embedded in a wall, a floor, etc. Additionally, various modifications are possible.

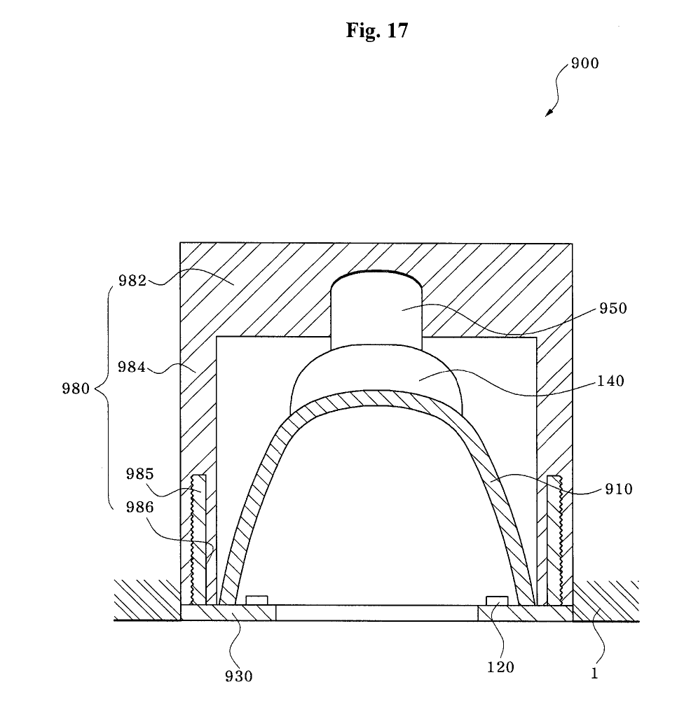

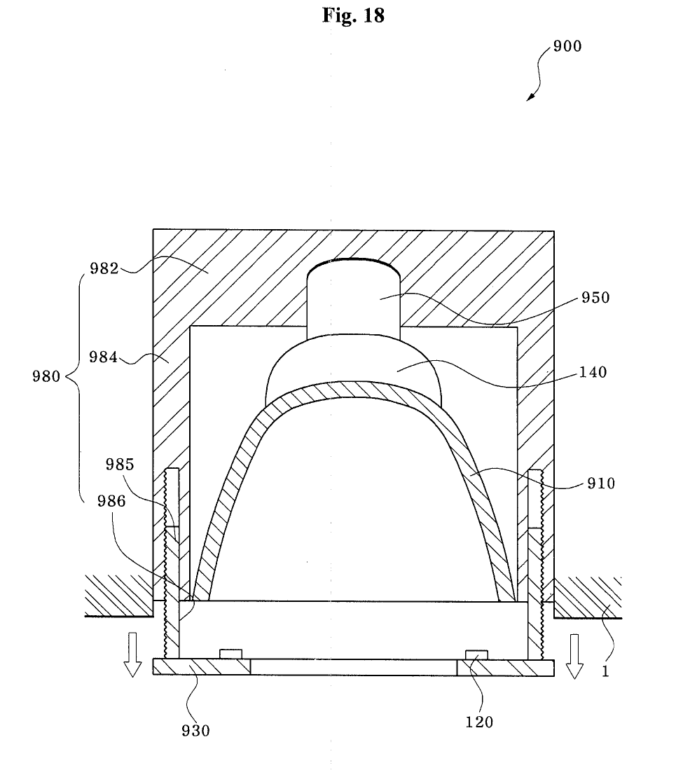

FIG. 17 is a sectional view of a lighting fixture according to a ninth embodiment, and FIG. 18 illustrates operation of the lighting fixture of FIG. 17.

Referring to FIGS. 17 and 18, the lighting fixture 900 according to the ninth embodiment includes a housing 980 mounted to be liftable. According to this embodiment, a mounting part 930 is coupled to the housing 980 to be raised or lowered. In this embodiment, the mounting part 930 is slidably coupled to the housing 980.

Specifically, the housing 980 includes a sliding member 985 slidably coupled to the housing 980. The sliding member 985 is slidably inserted into an insertion groove (reference numeral omitted) formed in an extension section 984 of the housing 980. The mounting part 930 is provided to a lower portion of the sliding member 985.

Here, the sliding member 985 may be formed on at least one side thereof with a plurality of projections (reference numeral omitted), which are engaged with a plurality of projections formed in the insertion groove. With the projections engaged with each other, the sliding member 985 may be secured in place and slide when subjected to a certain external force or more.

The lighting fixture 900 may further include an auxiliary reflecting part 986 inside the housing 980, i.e., inside the sliding member 985. The auxiliary reflecting part 986 is configured to reflect light emitted from the light source 120, and is made of the same or similar material as a reflecting part 910. According to this embodiment, when the light source 120 is positioned outside the reflecting part 910 by lowering the mounting part 930 from the reflecting part 910, some of light emitted from the light source 120 is reflected from the reflecting part 910 and the remainder is reflected from the auxiliary reflecting part 986.

In the lighting fixture 900 with the configuration according to this embodiment, the mounting part 930 is raised or lowered as needed, so that the distance between the light source 120 and the reflecting part 910 and between the light source 120 and the auxiliary reflecting part 986 may be adjusted to vary a lighting position, intensity of illumination, etc., thereby achieving various lighting effects.

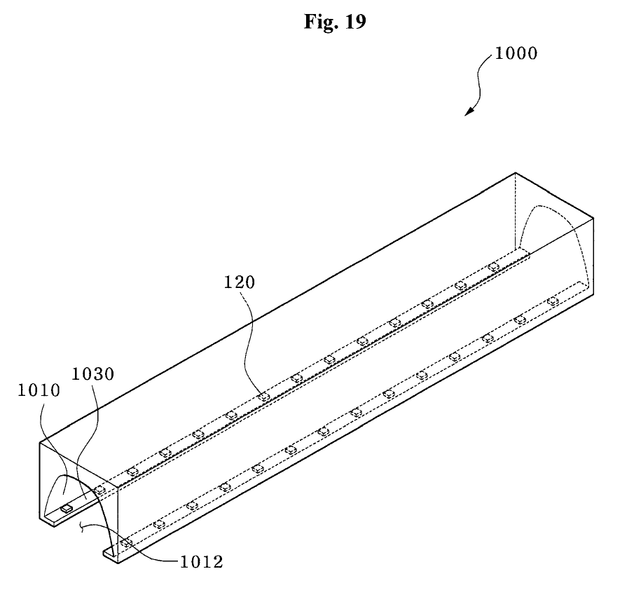

FIG. 19 is a perspective view of a lighting fixture according to a tenth embodiment.

Referring to FIG. 19, the lighting fixture 1000 according to the tenth embodiment includes a reflecting part 1010 and a mounting part 1030.

According to this embodiment, the reflecting part 1010 extends lengthwise in one direction and is formed with an opening 1012 which penetrates a lower side of the reflecting part 1010.

The mounting part 1030 disposed at a side of the opening 1012 of the reflecting part 1010 extends lengthwise in one direction along the length of the reflecting part 1010 and extends from a lower end of the reflecting part 1010 toward the opening 1012.

Further, a plurality of light sources 120 is arranged in a longitudinal direction of the mounting part 1030. The respective light sources 120 are spaced apart from each other in the longitudinal direction of the mounting part 1030 and are disposed inside the reflecting part 1010 to irradiate light toward an inner surface of the reflecting part 1010.

The lighting fixture 1000 of this embodiment can brightly illuminate a large area.

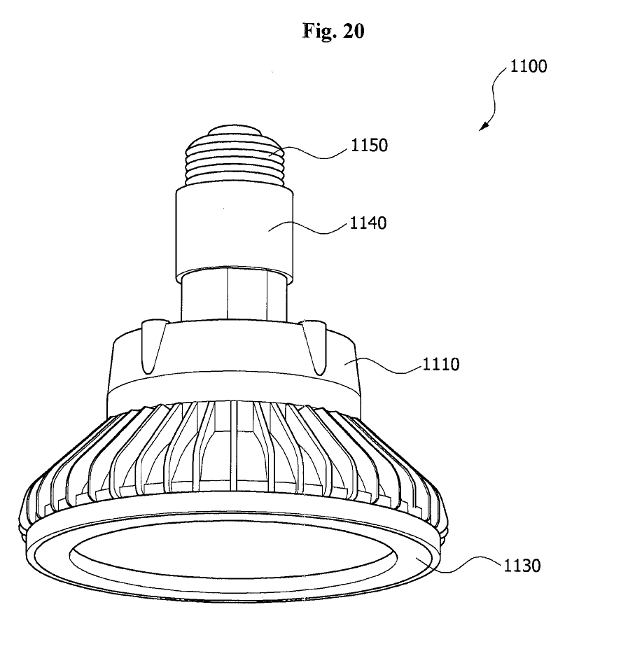

FIG. 20 is perspective view of a lighting fixture according to an eleventh embodiment.

Referring to FIG. 20, the lighting fixture 1100 according to the eleventh embodiment includes a reflecting part 1110, a mounting part 1130, a distance adjusting part 1140, and a power connecting part 1150.

The reflecting part 1110 is provided to the power connecting part 1150 to permit adjustment of the distance with regard to the power connecting part 1150. For example, the distance adjusting part 1140 adjusts a distance between the power connecting part 1150 and the reflecting part 1100. That is, the distance adjusting part 1140 adjusts the height of the reflecting part 1100 with regard to the power connecting part 1150 so as to adjust the distance between the power connecting part 1150 and the reflecting part 1110. Height adjustment using the distance adjusting part 1140 may be achieved by adjusting the height mechanically based on screw-coupling, adjusting the height hydraulically, and so on. Additionally, various height adjustments may be applied. Such height adjustment is well-known to those skilled in the art, and a detailed description thereof will be omitted herein. As such, since the reflecting part 1110 is provided to the lighting fixture to permit adjustment of the distance with regard to the power connecting part 1150, it is possible to adjust an area over which light is irradiated.

As such, in the lighting fixture according to an embodiment, light irradiated from the light source is reflected by the reflecting part and then exits the lighting fixture, so that the light can be indirectly transmitted to a user, thereby reducing glare.

In addition, according to the embodiment, the reflecting part, the light source, the circuit part and the power connecting part are combined into an integrated module, thereby permitting easy installation while providing a compact outer appearance.

Further, according to the embodiment, the light source includes at least one of the LED module and the OLED module, and lighting, intensity of illumination, color temperature, etc. of the light source may be adjusted through dimming control, thereby irradiating light at various intensities of illumination and color temperatures.

According to another embodiment, the light source may be mounted on the reflecting part through simple assembly, thereby facilitating manufacture and maintenance of the lighting fixture.

Further, according to a further embodiment, the light source is mounted on the mounting part by being inserted into a mounting groove, so that the light source can be prevented from being damaged by external force, and the reflecting part includes a heat dissipating section so that the light source can be prevented from being deteriorated due to overheating, thereby enhancing mechanical reliability.

Further, according to yet another embodiment, the mounting part or the housing may be liftable, as needed, so that a distance between the light source and the reflecting part can be adjusted to vary a lighting position, intensities of illumination, etc., thereby achieving various lighting effects.

Further, according to yet another embodiment, the lighting fixture includes multiple light sources on the mounting part extending lengthwise in one direction, thereby enabling illumination of a large area.

Although some embodiments have been provided to illustrate the invention, it will to be apparent to those skilled in the art that the embodiments are given by way of illustration, and that various modifications, changes, alternations, and equivalents thereof can be made without departing from the spirit and scope of the invention. The scope of the present invention should be limited only by the appended claims and equivalents thereof.

What is claimed is:

1. A lighting fixture comprising:
a reflecting part having an opening which penetrates the reflecting part;
a light source irradiating light toward the reflecting part;
a mounting part which mounts the light source thereon;
a circuit part disposed at an opposite side to the opening of the reflecting part and driving the light source; and
a power connecting part supplying power from outside to the circuit part.

2. The lighting fixture according to claim 1, wherein the mounting part is disposed at a side of the opening of the reflecting part.

3. The lighting fixture according to claim 1, wherein the mounting part extends toward a side of the opening and the light source is disposed at a side of the reflecting part.

4. The lighting fixture according to claim 1, wherein the mounting part extends outside the opening and the light source is disposed to irradiate light towards an outer side of the reflecting part.

5. The lighting fixture according to claim 1, wherein the mounting part is detachably mounted to the reflecting part.

6. The lighting fixture according to claim 1, wherein the light source is inserted into a mounting groove formed in the mounting part.

7. The lighting fixture according to claim 1, wherein the reflecting part further comprises a heat dissipating section for dissipating heat generated by the light source.

8. The lighting fixture according to claim 1, further comprising a diffusing part disposed at the opening.

9. The lighting fixture according to claim 1, wherein the mounting part is mounted to allow distance adjustment from the reflecting part.

10. The lighting fixture according to claim 1, wherein the reflecting part is mounted to allow distance adjustment from the circuit part.

11. The lighting fixture according to claim 1, further comprising a housing outside the reflecting part.

12. The lighting fixture according to claim 11, wherein the housing is mounted to be liftable.

13. The lighting fixture according to claim 1, wherein the mounting part extends lengthwise in one direction, and the light source is provided in plural number in a longitudinal direction of the mounting part.

14. The lighting fixture according to claim 1, further comprising a distance adjusting part which adjusts a distance between the power connecting part and the reflecting part.
